(19) United States
(12) Patent Application Publication
(10) Pub. No.: US 2025/0207332 A1
(43) Pub. Date: Jun. 26, 2025

(54) WATER-BASED BARRIER COATING OF NATIVE SUBSTANCES FOR PAPER, CARDBOARD OR MOULDED PULP

(71) Applicant: CHT Germany GmbH, Tübingen (DE)

(72) Inventors: Bernd HORRER, Pliezhausen (DE); Silvia HELD-BELLER, Gomaringen (DE); Monia BRUGNONI, Pfullingen (DE); Tilmann OBERLE, Tubingen (DE); Alexander RIEFERT, Ofterdingen (DE)

(21) Appl. No.: 18/848,981

(22) PCT Filed: Mar. 22, 2023
(86) PCT No.: PCT/EP2023/057320

§ 371 Date: Sep. 20, 2024

(30) Foreign Application Priority Data
Mar. 22, 2022 (DE) 10 2022 106 653.3

(51) Int. Cl. D21H 21/14; B05D 1/42; D21H 19/46; D21H 19/82

(52) U.S. Cl. CPC D21H 21/14; B05D 1/42; D21H 19/46; D21H 19/822; B05D 2203/22; B05D 2400/00; B05D 2401/20

(57) ABSTRACT

The invention relates to natural, depolymerized, powdered polymers and mixtures thereof and aqueous solutions prepared therefrom for the production of a barrier coating on paper, cardboard, or moulded pulp. The barrier coating is used to reduce the diffusion of oxygen, mineral and food oils, and fatty substances through the paper, cardboard or moulded pulp. A 2 wt. % of the aqueous solutions has a viscosity in a range of from 1 to 100 mPa·s as measured with a rotational viscometer at room temperature and 20 rotations per minute. The natural, depolymerized, powdered polymers are selected from a group of guar gum, tara gum, sesbania gum, locust bean gum, alginates, or carrageenans such that the barrier coating is free from halogenated polymers.

### CROSS-REFERENCE TO RELATED APPLICATION

This application is a national stage and claims the benefit of priority of co-pending PCT/EP2023/057320 filed on Mar. 22, 2023, entitled “WATER-BASED BARRIER COATING OF NATIVE SUBSTANCES FOR PAPER, CARDBOARD OR MOULDED PULP,” which claims the benefit of priority of German Patent Application 102022106653.3 filed on Mar. 22, 2022. The contents of each of PCT/EP2023/057320 and German Patent Application 102022106653.3 are incorporated in full by reference herein.

### TECHNICAL FIELD

The present invention relates to natural, depolymerized, powdered polymers and mixtures thereof and aqueous solutions prepared therefrom for the preparation of a barrier coating on paper, cardboard or moulded pulp. The barrier coating is used to reduce the diffusion of oxygen, mineral and food oils, and fatty substances through the paper or cardboard.

### BACKGROUND

There is extensive prior art for the application of barrier coatings to paper, cardboard or moulded pulp. The dominant majority of patent applications to date relate to the use of petrochemical-based film-forming materials. As an example, WO 2012/163821 entitled: “Paper and cardboard packaging featuring a barrier coating comprising a polymer mixture” may be mentioned here.

WO 2021/005451 A1 describes a multilayer system with barrier effect. The first layer is to be a so-called bio-barrier based on polysaccharides. Among them, guar is explicitly mentioned as a possible coating component. No further information or examples are given regarding the use of guar for coating of paper. Furthermore, no test results are given on the barrier effect of the paper coatings produced.

WO 2021/171016 A1 describes the use of alginate crosslinked with CaCl₂) as a native barrier coating. Guar gum and other polysaccharides are listed as thickeners to improve elasticity for the barrier coating. While a viscosity of 200 to 10,000 cP of the preferred natural polysaccharide is given, necessary concentration data on these measurements are lacking. In Example 1, for example, a polysaccharide solution with 10,000 mPa·s is applied. However, no information is given on the performance of the barrier or the application weight.

WO 2021/228695 A1 describes a paper-based packaging material which has a barrier coating as the first coating directly bonded to the carrier paper. On page 10 and in claim 2 of the patent application, guar and carrageenan are mentioned in a list of different synthetic and natural polymers. An example for the application of guar or carrageenan or for the barrier effect of the two polysaccharides is missing.

Due to the ever-increasing demand for environmentally friendly and sustainable solutions, paper, cardboard or moulded pulp manufacturers are working on environmentally friendly barrier coatings to protect the end product from external influences. Examples include mineral oil migration from the paper or cardboard into the end product or longer-lasting freshness of the packaged product by excluding oxygen. Another purpose is to protect the consumer from, for example, greasy fingers or soiled clothing due to contamination from greasy food.

The sustainable solutions include water-based coatings without solvents and the elimination of the use of plastic or aluminium foils, as well as fluorochemicals. Due to the ever-increasing discussion about microplastics in the environment, the European Regulation (EU) 2019/904 was finally passed in July 2021. This means that in the future, water-based coatings will have to do without synthetic polymers.

The cited prior art has various disadvantages in that only aqueous coating systems with a viscosity of max. 1,500 mPa·s, measured with a Brookfield viscometer at 20 rpm, can be applied with the common coating units on the paper machines, such as size or film press, engraving roll, blade coater, doctor blade coater, air knife, curtain coater or spray application, etc. Often, even a viscosity <500 mPa·s is necessary.

With the European Regulation (EU) 2019/904, which came into force on 3 Jul. 2021, such barrier coatings for paper, cardboard or moulded pulp intended for single use are now only permitted if the barrier coating consists of natural, unmodified polymers. Also not allowed are nature-identical polymers produced via a fermentation process. In common parlance, this regulation is referred to as the Single-used-plastic-directive, or SUPD for short. This abbreviation will also be used frequently in the following.

Aqueous solutions of cold-water soluble polysaccharides generally have very high viscosities. For example, guar gums have viscosities of between 4,000 to 8,000 mPa·s as a 1 wt % aqueous solution. Alginates have somewhat lower viscosities, but nevertheless 3,000 to 7,000 mPa's, from a 2 wt % solution is also common. Both viscosity figures were measured under the conditions given above. Due to the high viscosities, it is obvious that only highly diluted solutions can be applied with them. This leads to a dramatic reduction in the application volume and the associated barrier effect.

The second major drawback of the cited prior art is the lack of test results for the determination of barrier effects. None of the applications publish results for an oxygen, mineral oil, food oil or grease barrier.

For a long time, aqueous solutions of enzymatically degraded starch have been applied in the paper industry. Although this application would comply with the European Regulation (EU) 2019/904, SUPD, starch coatings show two serious disadvantages. First, a natural starch coating is very hard and brittle and breaks immediately when the paper is folded during subsequent application. This would completely destroy any barrier effect that may have existed. The second disadvantage is the insufficient barrier effect against oxygen and hydrophobic substances, such as mineral and edible oils, as well as fatty substances.

EP 0 030 443 describes a water-soluble phosphated guar product and a method for making it. The phosphated guar product is described to be excellently suited for the surface treatment of papers. The guar product is chemically modified and thus not in conformance with European Regulation (EU) 2019/904. The phosphated guar may be produced by depolymerizing guar gum under alkaline conditions in the presence of an oxidizing agent. The depolymerized guar is then used as starting material for producing phosphated guar.

US 2014/0243518 A1 discloses a method for preparing cationic galactomannans. It is generally described that galactomannans may be employed in the paper industry without further specifics. The cationic galactomannans are chemically modified.

EP 2 492 395 A1 describes oil and grease resistant treatment compositions. The oil and grease resistance are achieved by means of a fluorocarbon resin, a guar gum and an inorganic phosphate salt. Employment of a fluorocarbon resin is disclosed to be essential for obtaining such resistance. The use of such fluorochemicals is not environmentally friendly and sustainable.

As such, a need exists in the art for barrier coatings and associated methods that overcome the above limitations.

This background is provided as an illustrative contextual environment only. It will be readily apparent to those of ordinary skill in the art that the coatings and associated articles of manufacture, methods, and the like of the present disclosure may be implemented in other contextual environments as well.

### SUMMARY

The object of the present invention is to provide a barrier coating for paper or cardboard on a non-petrochemical basis using natural, unmodified polymers and mixtures thereof and aqueous solutions prepared therefrom. The barrier coating is intended to result in the reduction of diffusion of oxygen, mineral and food oils, and fatty substances through the paper or cardboard. A barrier coating for paper, cardboard or moulded pulp according to the invention is intended, on the one hand, to protect the goods to be packaged from external influences. On the other hand, the consumer is ensured pleasant use.

Thus, in a first embodiment of the present invention, a barrier coating for paper, cardboard or moulded pulp for reducing diffusion of oxygen, mineral and food oils and fatty substances through the paper, cardboard or moulded pulp based on natural depolymerized powdered polymers and mixtures thereof is provided. The natural, depolymerized, powdery polymers of the present invention preferably have a high degree of depolymerization. In a particular preferred embodiment, the degree of depolymerization is such that the viscosity of a 2 wt % aqueous solution of the natural depolymerized powdery polymers is in the range of from 1 to 100 mPa's, more preferably 1 to 50 mPa's, particularly 1 to 20 m·Pas (measured with Brookfield at room temperature and 20 rpm).

Additionally or alternatively, the natural powdered polymers are polysaccharides preferably selected from the group of polygalactomannans, such as guar, tara, sesbania or locust bean gum, alginates or carrageenans. The polymers may be exclusively of natural origin, without chemical modification. Comparable polymers, which are produced via possible fermentation processes, such as xanthan, welan, etc., are not included in the subject matter of the present invention. Additionally or alternatively, the barrier coating is free from halogenated polymers.

Additionally or alternatively, the barrier coating further may further include additives or adjuvants known per se, especially wetting agents, defoamers, plasticizers, fillers, sizing agents, hydrophobing agents, levelling agents, thickeners or colorants, which especially conform to European Regulation (EU) 2019/904. Additionally or alternatively, the additives and adjuvants may be selected from sodium gluconate, trisodium citrate, sodium lactate, potassium/sodium tartrate, sorbitol and/or sucrose and mixtures thereof.

In an additional or alternative embodiment, the barrier coating is utilized on at least one side of the paper, cardboard, or moulded pulp. Additionally or alternatively, the barrier coating may form at least one layer in a multilayer barrier coating. Additionally or alternatively, a areal application weights may be 0.3 to 10 g/m², based on a dry coating layer.

### DETAILED DESCRIPTION

Paper and cardboard are made from fibrous materials, which today are mainly obtained from the raw material wood. The most important fibrous materials are pulp, mechanical wood pulp and wastepaper pulp. Paper and cardboard are flat materials formed by dewatering a fibre suspension (pulp) on a wire. The resulting fibrous web is compacted and dried.

Paper and cardboard are distinguished, among other things, by their mass per unit area. Colloquially, a material with a basis weight in the range 150 g/m² to 600 g/m² is referred to as cardboard. Cardboard is typically thicker and stiffer than paper.

Moulded pulp is a type of packaging material made from recycled and cellulose paper. The pulp can be made from materials such as recycled cardboard, paperboard and newspapers. In fact, any paper-based product can be used. This includes items that have already been made from moulded pulp, have finished their use and need to be recycled again.

There are four basic types of moulded pulp. Thick-walled moulded pulp has rough edges and is used to transport goods from one place to another. Injection moulding is used to smooth or finish a thinner version of the thick-walled mould on at least one side. Thermoformed fibre mould is a heated mould made using three-dimensional moulds and vacuum forming. The final type, processed pulp, takes one of the other three forms and finishes it by adding an imprint, coating layer or sometimes seeds.

The exact process for making a moulded pulp depends on the function and the size required. The production of the pulp itself is a process common to all types. In fact, the basic pulp can be used to produce all four basic types. The paper products are fed to a pulper, which crushes the products into small pieces. Hot water is then added to produce a semi-liquid pulp. The pulp is then passed through a filter to remove all non-paper materials such as plastic.

Moulded pulp for manufacturing products such as egg cartons and beverage carriers is poured onto lubricated metal moulds. A vacuum pump then sucks the pulp onto the mould to create an even distribution of the pulp across the mould. Once the pulp is formed, it is placed in an oven to dry. The length of time a pulp mould is dried depends on the size and thickness.

Protection from oxygen: Excluding oxygen extends the freshness and shelf life of packaged food. This means that by extending shelf life throughout the value chain, i.e. transport, retail and consumer, food waste can be reduced.

Protection against mineral oil contamination: The use of recycled paper for the production of paper, cardboard or moulded pulp introduces contamination from mineral oil fractions, which originate, for example, from printed wastepaper. The problems are mainly caused by the two mineral oil fractions MOSH (Mineral Oil Saturated Hydrocarbons), as saturated mineral oil hydrocarbons, and MOAH (Mineral Oil Aromatic Hydrocarbons), as aromatic mineral oil hydrocarbons. Even at room temperature, volatile components of these fractions evaporate and become incorporated into the packaging material. Barrier coatings are applied to paper and cardboard to prevent this transfer from the packaging material to the packaged goods.

Pleasant use by the end user: A large use of papers and cardboard with a grease and oil barrier can be found in the fast-food industry. For example, burger wrapping papers are equipped with a fat barrier. The fat from the burger meat should not get through the paper onto the customer's hands. The corresponding folding boxes for larger burgers are also equipped with a fat barrier to also prevent fat from seeping through.

The task to be solved consists in particular in providing aqueous low-viscosity coating solutions of natural, unmodified polysaccharides with a solids content greater than 10% by weight. Furthermore, the coating for paper, cardboard or moulded pulp produced from the solution should be compliant with the European Regulation (EU) 2019/904 and have an excellent barrier effect against oxygen, mineral oil, edible oil and fats. In addition, the applied coating must have sufficient flexibility to maintain the barrier effect even after folding.

Thus, in a first embodiment of the invention, a barrier coating for paper, cardboard, or moulded pulp for reducing the diffusion of oxygen, mineral and food oils and fatty substances through the paper, cardboard or moulded pulp based on natural, depolymerized, powdery polymers, and mixtures thereof is provided.

The inventive barrier coating is based on natural, depolymerized, powdery polymers. Based on, in the sense of the present invention, particularly has the meaning that the natural depolymerized, powdery polymers are the major functional components of the barrier coating. Particularly, the amount of the polymers in the barrier coating may be in the range of from 85 to 100 wt %, more particularly 90 to 100 wt %, or 95 to 100 wt %, or 99 to 100 wt %. The barrier coating may consist solely of said natural, depolymerized, powdery polymers and mixtures thereof.

Natural polymer, in the sense of the present invention, particularly has the meaning that the polymers are obtained from nature and are employed without any further chemical modification (apart from depolymerization). Particularly, the natural polymers are not synthetically functionalized in any way (e.g. with a cationic or anionic functionalization) prior to using them in the barrier coating. The only modification of the polymers, which is included according to the present invention is a depolymerization, i.e. a shortening of the polymer chain. No chemical modification as such is performed when depolymerizing a polymer.

The barrier coating of the present invention is especially free from further modified polymers, particularly halogenated polymers. The barrier coating, in particular, may entirely consists of compounds conforming to European Regulation (EU) 2019/904, SUPD.

Surprisingly, it has now been found that from more or less strongly depolymerized natural polysaccharides, such as guar, alginate or carrageenan, low-viscosity solutions with a polymer-solid content of greater than 10% by weight and a viscosity of preferably up to 5,000 mPa's (measured with Brookfield at room temperature and 20 revolutions per minute), in particular up to 2,000 mPa·s, further preferably less than 1,500 mPa's (measured with Brookfield at room temperature and 20 revolutions per minute) may be produced. Papers coated with these polymer solutions show conformity to European Regulation (EU) 2019/904, SUPD, excellent barrier properties to oxygen, mineral oil, edible oil and fats, and excellent flexibility.

Another advantage lies in the simple preparation of the aqueous solutions from the depolymerized natural polysaccharides. For the starting polysaccharides, stirring aggregates with a high shear effect are necessary to dissolve the powders in water without lumps. The depolymerized polysaccharides can be dissolved in water very easily with a magnetic stirrer.

The natural, depolymerized, powdery polymers of the present invention preferably have a high degree of depolymerization. In a particular preferred embodiment, the degree of depolymerization is such that the viscosity of a 2 wt % aqueous solution of the natural depolymerized powdery polymers is in the range of from 1 to 100 mPa's, more preferably 1 to 50 mPa's, particularly 1 to 20 m·Pas (measured with Brookfield at room temperature and 20 rpm).

The natural polymers in powder form are

a) Polysaccharides from the Group of Polygalactomannans.

Galactomannans are reserve polysaccharides and are obtained from the endosperm of the seeds of various legumes. They are uniformly chains of β-1,4-linked mannopyranosides bearing α-1,6-linked side chains of galactopyranoside residues. The weight ratio of mannose to galactose is different in the various legume species.

The most important representative of these polysaccharides is guar gum. It is obtained from the seed of the guar bush (Cyamopsis tetragonoloba L.). It is grown in India, Pakistan, the USA (Texas, Arizona) and northern Australia. The weight ratio of mannose to galactose in guar gum is idealized at 2 to 1. The molecular weight is given as 50,000 to 8,000,000.

Another important representative of the galactomannans is locust bean gum. It is obtained from the seeds of the carob tree (Ceratonia Siliqua L.). It is cultivated in the Mediterranean region. The ideal weight ratio of mannose to galactose in locust bean gum is 4 to 1. The molecular weight is given as 50,000 to 3,000,000.

In recent years, tara gum from the seed of the tara tree (Caesalpinia Spinosa L.) from Peru, Ecuador and Kenya and cassia gum from the seed of the cassia shrub (Cassia tora and Cass obtusifolia) from India have gained in importance. The idealized weight ratio of mannose to galactose is 3 to 1 for tara gum and 5 to 1 for cassia gum. The molecular weights for cassia gum are 200,000 to 300,000; no values are currently given in the literature for tara gum.

Sesbania gum also belongs to the group of polygalactomannans. The main cultivation area is India, but commercial qualities are also known from Egypt. The weight ratio of mannose to galactose in sesbania gum, as in guar gum, is idealized at 2 to 1. The molecular weight is 2,000,000 to 3,000,000 g/mol. No information is currently available on the structural distribution of the galactose side group.

Molecular weight values were taken from Cassia Gum, Chemical and Technical Assessment (CTA) and Characterization of galactomannans derived from legume endosperms of genus Sesbania (Faboideae).

From the group of polygalactomannans, guar gum and locust bean gum are preferred in some embodiments of the invention. Additionally or alternatively, guar gum may be particularly preferred.

Alginic acid is found primarily in marine brown algae as a cell wall component (up to 40 wt. % of dry matter); it is made up of long filaments similar to cellulose (degree of polymerization approx. 1000) and has a similar supporting function. Alginic acid is a polysaccharide containing carboxy groups (C₆H₈O₆)ₙ, consisting of a mixture of the two uronic acids β-D-mannuronic acid- and α-L-guluronic acid, which are 1,4-glycosidically linked in alternating proportions to form linear chains. The chains contain either longer segments (blocks) of only one uronic acid (M-M-M- or G-G-G-G-), or both basic elements occur alternately (-G-M-G-M-G-); the carboxy groups are not esterified. The molecular weight is between 30,000 to 200,000 daltons (180 to 900 uronic acid units). The salts of alginic acid are called alginates.

c) The Polysaccharide Carrageenan Also Comes from Algae.

Carrageenan is a sulfated galactan extracted from the red algae that count as florids. Carrageenan is precipitated from the hot water extract of the algae. Carrageenan is a colourless to sand-coloured powder with a molecular weight between 100,000 to 800,000 Daltons and a sulfate content of about 25% by weight, which is very easily soluble in warm water. Carrageenan is divided into three main components, the k-, i- and A-types, with different properties.

The information on alginic acid and carrageenan is taken from Thieme Römpp Online Chemistry Encyclopedia (retrieved February 2022).

From the information on polygalactomannans, alginic acid and carrageenan, it is clear that these polysaccharides are polymers of natural origin.

The depolymerization and/or hydrolysis of the polysaccharides takes place in powder form with the addition of acids. After hydrolysis, the degraded polysaccharide is neutralized with a base into the neutral pH range.

Preferably, the depolymerization is carried out in the absence of reagents, which may react with the polymer and chemically modify it. It is particularly preferred that no oxidizing agents are employed in the process of depolymerization and that depolymerization is performed exclusively by applying acids.

In particular, mineral acids such as hydrochloric acid, sulfuric acid, nitric acid, amidosulfonic acid, methanesulfonic acid, phosphoric acid and others, as well as carboxylic acids such as citric acid, tartaric acid, lactic acid, formic acid, gluconic acid and others can be used as acids. In general, acids with pKa values of <4.5 can be used. Preferably, methanesulfonic acid, phosphoric acid, citric acid and lactic acid are used for hydrolysis. Particularly preferred are methanesulfonic acid and citric acid.

All common bases, in particular aqueous alkalis such as caustic soda and caustic potash solution, but also ammonia or amines can be used for neutralization. Sodium hydroxide and potassium hydroxide are preferred in some embodiments, and sodium hydroxide is particularly preferred in some embodiments.

The degree of hydrolysis can be controlled by the amount and concentration of acid used, the duration of the acid treatment, and the temperature of the treatment.

The viscosities of the aqueous solutions from the powdered samples are measured after a swelling time of 2 hours using a Brookfield rotational viscometer (type RVT). The measurements took place at room temperature (22° C.±2° C.) and the specified rotations per minute (rpm).

The powdered depolymerized polysaccharides exhibit, as a 10 wt. % aqueous solution, a viscosity of at most 5,000 mPa·s, measured at 20 rpm. Viscosities of maximum 2,000 mPa·s are preferred and viscosities of up to 1,500 mPa·s are particularly preferred. Viscosities may particularly be in the range of from 10 to 1000 mPa·s, 10 to 250 mPa·s or 10 to 200 mPa·s.

According to some embodiments of the invention, the carrier substrate, paper, cardboard, or moulded pulp are coated with the aqueous polysaccharide solutions.

The coating of the paper and cardboard substrates can be carried out directly “online” on the paper machine during the paper and cardboard production or “offline” in a downstream separate coating process.

Coating processes known to the skilled person are suitable for coating, such as size or film press, engraving roller, blade coater, doctor blade coater, air knife, curtain coater, etc., as well as spraying units.

The barrier coating is applied to at least one side of the carrier substrate and forms at least one layer in the case of a multilayer barrier coating. The areal application weights are preferably 0.3 to 10 g/m², based on a dry coating layer.

Another preferred feature of the invention is the mixing of the depolymerized and/or hydrolyzed polysaccharides with each other, as well as the addition of further powdered additives: Thus, the non-ionic polygalactomannans can be mixed with the anionic polysaccharides based on alginate and/or carrageenan.

For example, the mixing ratios are in the range of: 10 to 100% by weight of polygalactomannan, 0 to 20% by weight of alginate and/or carrageenan, and/or 0 to 10% by weight of other powdered additives.

Particularly preferred in this sense are the powdered additives selected from sodium gluconate, trisodium citrate, sodium lactate, potassium/sodium tartrate, sorbitol and/or sucrose and mixtures thereof.

The aqueous polymer solution used for coating paper, cardboard or moulded pulp can consist solely of the powdered polysaccharides dissolved in water for use according to the invention. However, it may also contain other additives known per se, e.g. wetting agents, defoamers, plasticizers, fillers, sizing agents (e.g. AKD=alkylated ketene dimers), hydrophobing agents (e.g. wax emulsions), levelling agents, thickeners or dyes. The amount of further additive may be in the range of from 0 to 15 wt %, preferably 0 to 10 wt %, more preferably 0 to 5 wt %, particularly 0 to 1 wt %. In a preferred embodiment, the inventive barrier coating consists of the aforementioned natural depolymerized powdery polymers and the aforementioned additives in the aforementioned amounts.

### EXAMPLES

### Preparation of Depolymerized Polysaccharides

### Preparation of Hydrolyzed Guar Gum

In a heatable 25-liter horizontal reactor from Drais, 3,500 g of guar gum 200 mesh were introduced at room temperature and the reactor was sealed. With stirring, 678 g of a mixture of isopropanol (580 g) and water (118 g) was injected and stirred for 5 minutes. Then 360 g of a mixture of water (40 g), isopropanol (100 g) and Lutropur® MSA (220 g) was injected and the reactor contents were heated to 80° C. within 60 minutes. Stirring was carried out at this temperature for 60 minutes. Subsequently, neutralization was achieved by injecting 768 g of a mixture of NaOH 50 wt % (128 g), water (190 g) and isopropanol (450 g), and hydrolysis was stopped. The excess isopropanol/water was distilled off under vacuum to a residual moisture of <10%. The dried reaction product was then ground and sieved through a 500 μm sieve.

The viscosity of the obtained product (HG-1) is shown in Table 1, in comparison with the starting guar gum.

### Raw Materials Used:

Lutropur® MSA from BASF=methanesulfonic acid 70 wt. %.
Guar gum 200 mesh:
Specification: Particle size: At least 96% through 200 mesh sieve. Polygalactomannan content: At least 82% by weight, Viscosity 1 wt % after 2 hours: At least 5,000 mPa·s measured with Brookfield (type RVT), at room temperature and 20 rpm.

### Preparation of Hydrolyzed Alginate

In a heatable 25-liter horizontal reactor from Drais, 3,500 g of alginate 40 mesh were placed at room temperature and the reactor was closed. With stirring, 650 g of a mixture of isopropanol (600 g) and water (50 g) was injected and stirred for 5 minutes. Then 138 g of a mixture of water (15 g), isopropanol (100 g) and citric acid 50% (23 g) was injected and the reactor contents were heated to 80° C. within 60 minutes. Stirring was carried out at this temperature for 60 minutes. Subsequently, neutralization was achieved by injecting 754.5 g of a mixture of NaOH 50 wt % (14.5 g), water (190 g) and isopropanol (550 g), and hydrolysis was stopped. The excess isopropanol/water was distilled off under vacuum to a residual moisture content of <10%. The dried reaction product was then ground and sieved through a 500 μm sieve.

The viscosity of the obtained product (HA-1) is shown in Table 1 in comparison with the starting alginate.

### Raw Materials Used:

Alginate 40 Mesh:
Specification: Particle size: At least 95 wt % through 40 mesh sieve. Viscosity 2 wt % after 2 hours: At least 3,500 mPa·s measured with Brookfield (type RVT), at room temperature and 20 rpm pH 2 wt %: 7.0 to 8.5
   Preparation of Powder Blends from the Depolymerized Polysaccharides

Simple powder mixtures were prepared from the two hydrolyzed polysaccharides in the following weight ratios.

$$PM - 1 = 95 \% + HG - 1 + 5 \% HA - 1 \qquad a )$$

$$PM - 2 = 90 \% + HG - 1 + 10 \% HA - 1 \qquad b )$$

The viscosities of the two polysaccharide mixtures are also shown in Table 1.

As a comparative example, Table 1 shows the viscosity of Amitroglue® G2 30.226 from AGRANA as an enzymatically hydrolyzed starch.

### Preparation of the Aqueous Solutions:

### a) Starting Polysaccharide

The aqueous solutions had to be prepared on an aggregate with high shear. A Dispermat (Model AE 04) from VMA Getzmann was used for this purpose.

The necessary amount of soft water (with a hardness level of <5° dH) was placed in an appropriate vessel. The toothed disc (diameter=70 mm) of the Dispermat was immersed. The stirrer speed was initially set to 500 rpm. The powder was then slowly sprinkled in. As soon as an increase in viscosity was perceptible, the rotation speed was increased to 1,000 rpm. Care was taken to ensure that no undissolved gel lumps were formed during the dissolving process. After complete addition, stirring was continued for 5 minutes. The viscosity was measured after 2 hours swelling time.

### b) Depolymerized Guar Gum or Alginate

The aqueous solution of hydrolyzed polysaccharides could be prepared very easily, without the need for a high gravity aggregate.

The required amount of soft water was placed in a beaker. A magnetic stir bar was added, the beaker was placed on a commercial magnetic stirrer and the stirrer was turned on at medium speed, then the powder was sprinkled into the water. The water could be heated to 40 to 50° C. for a faster dissolution rate. After the powder had dissolved completely, the viscosity was also determined after 2 hours. If necessary, the solution was cooled to 22° C.±2° C.

TABLE 1
Brookfield viscosities, measured in mPa's after 2 hours swelling time

| Concen- | | Starting | | Starting | | | | |
|---|---|---|---|---|---|---|---|---|
| tration | RPM | guar gum | HG-1 | Alginate | HA-1 | PM-1 | PM-2 | Starch¹⁾ |
| 1% by | 5 | 11,700 | 8 | 550 | 10 | 8 | 10 | 5 |
| weight | 20 | 5,250 | 8 | 485 | 10 | 9 | 10 | 5 |
| | 100 | 1,700 | 15 | 360 | 16 | 14 | 14 | 10 |
| 2% by | 5 | 85,000 | 8 | 6,700 | 12 | 8 | 10 | 5 |
| weight | 20 | 26,800 | 12 | 4,700 | 15 | 12 | 14 | 5 |
| | 100 | 6,450 | 20 | 2,650 | 20 | 20 | 20 | 15 |
| 3% by | 5 | — | 8 | 30,400 | 15 | 10 | 12 | 5 |
| weight | 20 | — | 14 | 20,200 | 20 | 15 | 16 | 10 |
| | 100 | — | 26 | 9,700 | 20 | 22 | 22 | 15 |
| 10% by | 5 | — | 135 | — | 320 | 140 | 150 | 5 |
| weight | 20 | — | 90 | — | 180 | 95 | 100 | 10 |
| | 100 | — | 90 | — | 130 | 90 | 90 | 20 |
| 20% by | 5 | — | 360 | — | 3,900 | 500 | 730 | 20 |
| weight | 20 | — | 230 | — | 1,800 | 290 | 400 | 25 |
| | 100 | — | 175 | — | 900 | 190 | 260 | 45 |

a. = Amitroglue ® G2 30.226

### Preparation of Paper Coatings

Papers with the following specification were used for testing the barrier effect:

### Paper A:

Untreated, bleached virgin fiber paper,
Weight per unit area=50 g/m²;
Bendtsen porosity=253 mL/min

### Paper B:

Untreated, bleached virgin fiber paper,
Basis weight=40 g/m²,
Bendtsen porosity=17.5 mL/min

### Implementation of the Paper Coating

An automatic film applicator from Byk Instruments (Model No.: AG-2150) with a profile doctor blade (creasing=24 μm) was used as the coating unit. The doctor blade speed during coating was 500 mm/s.

For coating, the paper was cut to an A4 size. The paper was clamped in the holders, the doctor blade was inserted, and the aqueous coating solution was applied with a pipette in front of the doctor blade. After application of the solution, the coating unit was started immediately. The paper was then dried in the drying oven at 80° C. for 5 minutes.

### Method for Determining the Coating Weight (Dry)

The paper to be coated was weighed before coating using a commercially available top-loading laboratory balance (accuracy: 0.01 g). Immediately after coating, the wet paper was weighed again. After drying, the area of the coating was measured with a ruler. The solids content of the coating solution was determined using a Mettler-Toledo drying balance, Model HC103 Moisture Analyzer. With the data obtained, the dry coating weight was calculated using the following formula.

$$coated area A in [ {m}^{2} ] = \frac{length [ cm ] * width [ cm ]}{10 , 000}$$

$$dry mass coating [ g ] = ( mass ( paper + coating ) [ g ] - mass ( paper ) [ g ] ) * solid content [ \% ]$$

$$applied weight [ \frac{g}{{m}^{2}} ] = \frac{dry mass coating [ g ]}{coated area [ {m}^{2} ]}$$

The result of the calculation is given with an accuracy of one decimal place.

Measurement of the barrier effect

### a) Barrier Test Against Gaseous Mineral Oil Constituents.

The method used was analogous to WO 2012/163821 page 12, test method 2.

The vessels used for this test were an EZ-Cup Vapometer 68-3000 from Thwing-Albert Instrument Company. Otherwise, the procedure was identical. The result of the HVTR=Hexane Vapor Transmission Rate is given as weight loss in grams per 1 m² paper surface within one day (g/m² d).

b) Barrier test against grease and oil

For testing this property, there is a standardized method of the “Technical Association of the Pulp and Paper Industry”, Tappi for short. The method bears the number Tappi T 559 with the designation “Grease resistance test for paper and paperboard”.

Commonly known as the kit test, the method describes a procedure for testing the degree of repulsion and/or anti-absorbency of paper or paperboard treated with fluorochemical sizing agents. The fluorochemical agents can impart both lipophobic and hydrophobic properties to the paper by reducing the surface energy of the sheet. This is done by treating the surface of the fibres without forming a continuous film. This test was originally developed to allow paper manufacturers to determine when the applied fluorochemical was incorporated into the sheet and the approximate level of resistance. To do this, production samples were tested with a series of numbered reagents (with different surface tension and viscosity or “aggressiveness”) that were in bottles in a specially designed kit. The solution with the highest number (the most aggressive) that remained on the surface of the paper without causing failure was given the “kit rating” (hence the term “kit test”). This concept is the basis for the current classical method.

For barrier coatings, which do not use fluorochemicals, this method is not very meaningful. Therefore, a simple and practical test was developed. For the test, a paper container was folded and commercially available sunflower oil (brand: Gut & Günstig sunflower oil from EDEKA) was poured in. It was evaluated after certain time intervals whether the oil penetrated through the paper. The simple term “boat test” is used to denote the test.

### Procedure “Boat Test”

The substrate to be tested (paper or cardboard) was cut to a size of 7×7 cm. A 1 cm wide strip from each side was folded over at an angle of 90° so that the coated side was on the inside. The resulting corners were folded over at the sides to form a square vessel, the so-called “boat”.

The resulting “boat ship” was now placed on a gray cardboard and the contact surface marked on the cardboard at the corners. The underlaid cardboard showed very easily by dark spots when the oil penetrated through the paper. 9 ml of commercial sunflower oil was poured into the boat. Evaluation was performed visually after 10 and 60 minutes and after 24 hours. Results were expressed as percent penetration relative to the total area of the boat.

### c) Assessment of the Flexibility of the Barrier Coating

For this determination, the “boat test” listed above is modified. After the paper has been cut to size (7×7 cm), the first step is to fold the paper on the diagonal. The paper is folded 180° for the fold and the edge is lightly traced with a scraper. Then the paper is unfolded, and the method as described above is carried out. The results are given as percentage penetration in the fold.

### d) Measurement of the Oxygen Barrier

The oxygen permeability was determined according to DIN 53380-3.

The measurement area was 5 cm²

### Results Barrier Effect

TABLE 2
Results of the barrier effect tests

| | Dry | | | | | |
|---|---|---|---|---|---|---|
| | application | KIT | HVTR | Boat test | | |
| Coating | [g/m²] | test | [g/m² d] | 10 min | 60 min | 24 h |

Paper A:

| | | | | | | |
|---|---|---|---|---|---|---|
| without | — | <1 | >2,000 | 50% | 100% | 100% |
| HG-1 | 3.2 | <1 | 1,177 | 5% | 15% | 85% |
| PM-1 | 3.3 | 1 | 323 | 0% | 2% | 35% |
| PM-2 | 3.2 | 2 | 109 | 0% | 1% | 30% |
| Starch¹⁾ | 3.4 | <1 | >2,000 | 10% | 40% | 100% |

Paper B:

| | | | | | | |
|---|---|---|---|---|---|---|
| without | — | 1 | >2,000 | 15% | 45% | 100% |
| HG-1 | 3.1 | 3 | 63 | 0% | 0% | 15% |
| PM-1 | 3.0 | 4 | 39 | 0% | 0% | 7% |
| PM-2 | 3.2 | 5 | 18 | 0% | 0% | 4% |
| Starch¹⁾ | 3.5 | 1 | 523 | 0% | 15% | 45% |

a. = Amitroglue ® G2 30.226

TABLE 3
Results of tests c) regarding the flexibility of the barrier coating

| | Dry | | | |
|---|---|---|---|---|
| | application | Boat test in fold | | |
| Coating | [g/m²] | 10 min | 60 min | 4 h |

Paper A:

| | | | | |
|---|---|---|---|---|
| without | — | 70% | 100% | 100% |
| HG-1 | 3.2 | 10% | 25% | 90% |
| PM-1 | 3.3 | 2% | 10% | 65% |
| PM-2 | 3.2 | 1% | 5% | 50% |
| Starch¹⁾ | 3.4 | 50% | 80% | 100% |

Paper B:

| | | | | |
|---|---|---|---|---|
| without | — | 20% | 40% | 70% |
| HG-1 | 3.3 | 5% | 15% | 35% |
| PM-1 | 3.2 | 1% | 5% | 20% |
| PM-2 | 3.0 | 0% | 3% | 15% |
| Starch¹⁾ | 3.5 | 10% | 25% | 50% |

a. = Amitroglue ® G2 30.226
¹⁾= Amitroglue ® G2 30.226

TABLE 4
Results for oxygen barrier effect
Paper B:

| | Dry | |
|---|---|---|
| | application | Oxygen Transmission Rate (OTR) |
| Coating | [g/m²] | [cm³/m² · d · bar] |
| without | — | 8,143 |
| HG-1 | 6.1 | 522 |
| PM-1 | 6.2 | 319 |
| PM-2 | 5.9 | 165 |
| Starch¹⁾ | 6.4 | 1,283 |

¹⁾= Amitroglue ® G2 30.226

The results show the excellent barrier effect and flexibility of the hydrolyzed polysaccharides also in comparison to a coating with hydrolyzed starch.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims.

1. Barrier coating for paper, cardboard or moulded pulp for reducing the diffusion of oxygen, mineral and food oils and fatty substances through the paper, cardboard or moulded pulp based on natural, depolymerized, powdery polymers and their mixtures.

2. Barrier coating according to claim 1, characterized in that the polymers are selected from the group of polygalactomannans, especially guar gum, tara gum, sesbania gum, locust bean gum, alginates or carrageenans.

3. Barrier coating according to claim 1 or 2, further comprising additives or adjuvants known per se, especially wetting agents, defoamers, plasticizers, fillers, sizing agents, hydrophobing agents, levelling agents, thickeners or colorants, which especially conform to European Regulation (EU) 2019/904.

4. Barrier coating according to claim 3, characterized in that the additives or adjuvants are selected from sodium gluconate, trisodium citrate, sodium lactate, potassium/sodium tartrate, sorbitol and/or sucrose and mixtures thereof.

5. Process for the preparation of a barrier coating according to any one of claims 1 to 4 by depolymerization and/or hydrolysis of the polymers in the powdery state with addition of acids and subsequent neutralization of the degraded polymer with a base into the neutral pH range.

6. Process according to claim 5, characterized in that acids with pka values of <4.5 are used.

7. Process according to claim 5 or 6, characterized in that mineral acids, especially hydrochloric acid, sulfuric acid, nitric acid, amidosulfonic acid, methanesulfonic acid and/or phosphoric acid; carboxylic acids, especially citric acid, tartaric acid, lactic acid, formic acid and/or gluconic acid and mixtures thereof are used as acids.

8. Process according to one of claims 5 to 7, characterized in that sodium hydroxide and potassium hydroxide, especially sodium hydroxide solution and potassium hydroxide solution, are used as base.

9. Process according to any one of claims 5 to 7, characterized in that an aqueous solvent is added to the depolymerized and/or hydrolyzed polymers under the action of shear forces.

10. Process according to claim 9, characterized in that the solids content of polymers is adjusted to at least 10% by weight.

11. Process according to one of claims 5 to 10, characterized in that additives or adjuvants known per se, especially wetting agents, defoamers, plasticizers, fillers, sizing agents, hydrophobing agents, levelling agents, thickeners or dyes are added, which especially conform to European Regulation (EU) 2019/904.

12. Process according to claim 11, characterized in that the additives or adjuvants are selected from sodium gluconate, trisodium citrate, sodium lactate, potassium/sodium tartrate, sorbitol and/or sucrose and mixtures thereof.

13. Process according to one of claims 5 to 12, characterized in that a viscosity in the range of up to 5,000 mPa·s (measured with Brookfield at room temperature and 20 revolutions per minute), especially up to 2,000 mPa·s, is set.

14. Use of a coating solution obtainable by a process according to any one of claims 5 to 13 for coating paper or cardboard.

15. Use according to claim 14 online on the paper machine during paper and cardboard production or offline in a downstream separate coating process, especially with known coating processes selected from size or film presses, engraving rollers, blade coaters, doctor blade coaters, air knives and/or curtain coaters, and by spray applications.

16. Paper, cardboard or moulded pulp comprising a barrier coating according to any one of claims 1 to 4.

17. The paper, cardboard or moulded pulp of claim 16 comprising the barrier coating on at least one side of the paper or cardboard.

18. The paper, cardboard or moulded pulp of claim 16 or 17 comprising at least one layer in a multilayer barrier coating.

19. The paper, cardboard or moulded pulp according to one of claims 16 to 18, characterized in that the areal coating weight is 0.3 to 10 g/m², based on a dry coating layer.
